(19) United States
(12) Patent Application Publication
(10) Pub. No.: US 2013/0290294 A1
(43) Pub. Date: Oct. 31, 2013

(54) EVALUATION BY NESTED QUERIES

(71) Applicants: Matthew Steven Fuller, Medfield, MA (US); Charles Edward Bear, Hudson, MA (US)

(72) Inventors: Matthew Steven Fuller, Medfield, MA (US); Charles Edward Bear, Hudson, MA (US)

(21) Appl. No.: 13/458,142

(22) Filed: Apr. 27, 2012

(51) Int. Cl. G06F 17/30

(52) U.S. Cl. 707/714; 707/774; 707/E17.017

(57) ABSTRACT

A system, method, and non-transitory computer readable medium are disclosed herein to optimize nested queries. At least one field is associated with each row of data evaluated by at least one nested query. A value is assigned to the at least one field so as to indicate whether each row of data satisfies the at least one nested query. The at least one field associated with each row of data is evaluated to determine satisfaction of the at least one nested query.

### BACKGROUND

Structured Query language (“SQL”) is widely used by software professionals to query relational databases. One powerful feature of SQL is the nested query. Nested queries are sub-queries embedded within a larger query such that the output thereof becomes input for the larger query. The need for such queries typically arises when sought after data depends on multiple tables within the database.

Database management systems (“DBMS”) are typically equipped with processing subsystems known as optimizers. Such optimizers aim to provide a runtime engine of the DBMS with the most efficient plan for executing a received query. By way of example, the following query may be received by a DBMS:
select* from foo where a IN (select x from bar where bary=foo.b) AND b IN (select y from bar where bar.x=foo.a)

The query shown above includes two nested queries within parenthesis: (select x from bar where bar.y=foo.b) and (select y from bar where bar.x=foo.a). Since execution of each nested query would require multiple evaluations of every row in table foo, an optimizer may devise a plan to filter out rows that fail the first nested query such that the second nested query only evaluates the satisfactory rows. Therefore, if only one thousand of one million rows stored in table foo satisfy the first nested query, whose predicate is “bar.y=foo.b,” the predicate of the second nested query, which is “bar.x=foo.a,” would only evaluate the one thousand rows. This is more efficient than evaluating one million rows multiple times. Optimizers may devise different plans for different types of queries.

### BRIEF DESCRIPTION OF THE DRAWINGS

FIG. 1 is an illustrative system in accordance with aspects of the disclosure herein.

FIG. 2 is a flow diagram of an illustrative method in accordance with aspects of the disclosure herein.

FIG. 3 is a working example of nested-query optimization in accordance with the techniques disclosed herein.

FIG. 4 is a continuation of the working example shown in FIG. 3.

### DETAILED DESCRIPTION

As noted above, optimizers of a query processing subsystem may generate a plan to execute nested queries efficiently in order to minimize the database workload. However, certain optimizations such as the plan described above cannot be used for all types of queries. Certain types of queries may lead to erroneous results if the aforementioned optimization plan is applied. For example, the following query may be received by a DBMS:
select * from foo where a IN (select x from bar where bar.y=foo.b) OR b IN (select y from bar where bar.x=foo.a)

The two nested queries above are joined with a disjunctive “OR” expression. Optimization techniques may cause the first nested query to filter out rows of data that could have satisfied the second nested query. Therefore, every row of table foo must be evaluated twice to obtain accurate results. Such extra processing may hinder database performance when a table contains millions of rows therein. Database performance may be further diminished if such queries are executed frequently.

In view of the foregoing, various examples disclosed herein provide a system, method, and non-transitory computer readable medium to optimize nested queries. In one aspect, at least one field may be associated with each row of data evaluated by at least one nested query. In a further aspect, a value may be assigned to the at least one field so as to indicate whether each row of data satisfies the at least one nested query. In yet a further aspect, the at least one field associated with each row of data evaluated by the at least one nested query may be evaluated to determine satisfaction thereof.

The techniques disclosed herein optimize any type of query expression while providing accurate results thereto. As such, users are provided with greater flexibility when coding complex queries without diminishing database performance. The aspects, features and advantages of the application will be appreciated when considered with reference to the following description of examples and accompanying figures. The following description does not limit the application; rather, the scope of the application is defined by the appended claims and equivalents.

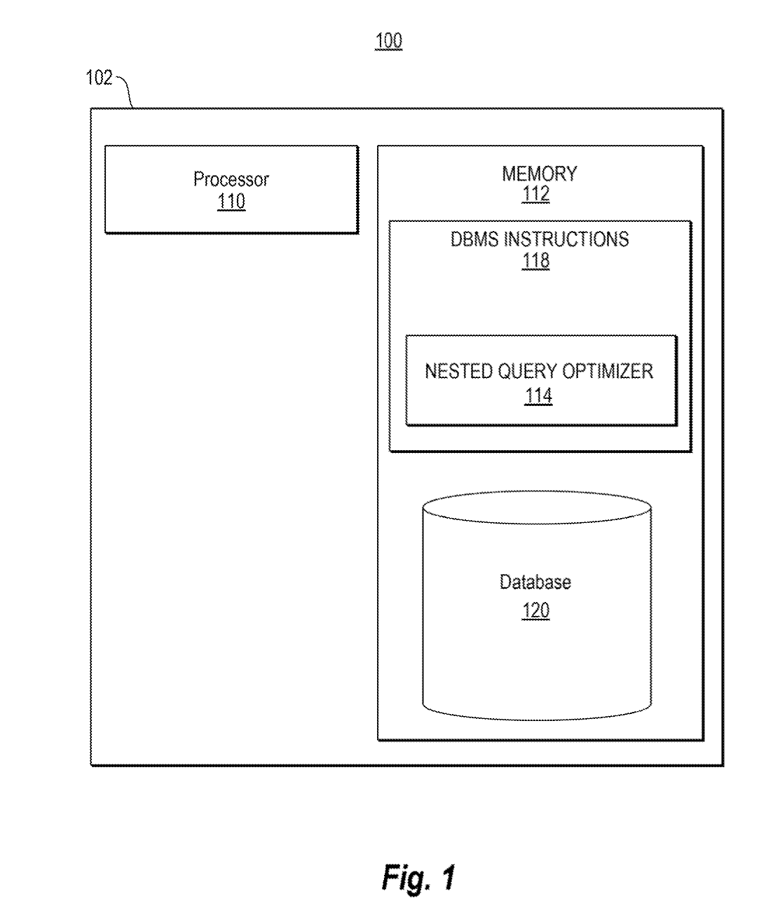

FIG. 1 presents a schematic diagram of an illustrative system 100 depicting a computer 102 that may comprise any device capable of processing instructions and transmitting data to and from other computers, including a laptop, a full-sized personal computer, a high-end server, or a network computer lacking local storage capability. Moreover, computer 102 may comprise a mobile device capable of wirelessly exchanging data with a server, such as a wireless-enabled PDA, or a tablet PC. Computer 102 may include all the components normally used in connection with a computer. For example, the computer may have a keyboard, a mouse and/or various other types of input devices such as pen-inputs, joysticks, buttons, touch screens, etc., as well as a display, which could include, for instance, a CRT, LCD, plasma screen monitor, TV, projector, etc.

Computer 102 may communicate with other computers via a network, which may be a local area network (“LAN”), wide area network (“WAN”), the Internet, etc. Computer 102 may use various protocols to communicate with other computers over the network. Such protocols may include virtual private networks, local Ethernet networks, private networks using communication protocols proprietary to one or more companies, cellular and wireless networks, instant messaging, HTTP and SMTP, and various combinations of the foregoing.

Computer 102 may be equipped with a processor 110 and memory 112. Memory 112 may store DBMS instructions 118 which may be retrieved and executed by processor 110. Furthermore, memory 112 may contain a database 120, which may be retrieved, manipulated, or stored by processor 110. In one example, memory 112 may be a random access memory (“RAM”) device. Alternatively, memory 112 may comprise other types of devices, such as memory provided on floppy disk drives, tapes, and hard disk drives, or other storage devices that may be directly or indirectly coupled to computer 102. The memory may also include any combination of one or more of the foregoing and/or other devices as well. The processor 110 may be any number of well known processors, such as processors from Intel® Corporation. In another example, processor 110 may be a dedicated controller for executing operations, such as an application specific integrated circuit (“ASIC”).

Although FIG. 1 functionally illustrates the processor 110 and memory 112 as being within the same block, it will be understood that the processor and memory may actually comprise multiple processors and memories that may or may not be stored within the same physical housing. For example, any one of the memories may be a hard drive or other storage media located in a server farm of a data center. Accordingly, references to a processor, computer, or memory will be understood to include references to a collection of processors, computers, or memories that may or may not operate in parallel.

Although the architecture of database 120 is not limited to any particular database structure or product, the data thereof may be stored in computer registers, in a relational database as tables having a plurality of different columns and records, XML documents or flat files. The data stored in database 120 may comprise any information sufficient to identify the relevant data, such as numbers, descriptive text, proprietary codes, references to data stored in other areas of the same memory or different memories (including other network locations) or information that is used by a function to calculate the relevant data.

Computer 102 may be configured as a database server. In this regard, computer 102 may be capable of communicating data with a client computer such that computer 102 uses a network to transmit information for presentation to a user of a remote computer. Accordingly, computer 102 may be used to obtain information from database 120 for display via, for example, a web browser executing on a remote. computer. Computer 102 may also comprise a plurality of computers, such as a load balancing network, that exchange information with different computers of a network for the purpose of receiving, processing, and transmitting data to multiple client computers. In this instance, the client computers will typically still be at different nodes of the network than any of the computers comprising computer 102.

DBMS instructions 118 may comprise any set of instructions to be executed directly (such as machine code) or indirectly (such as scripts) by the processor(s). In that regard, the terms “instructions,” “steps” and “programs” may be used interchangeably herein. The instructions may be stored in any computer language or format, such as in object code or modules of source code. Furthermore, it is understood that DBMS instructions 118 may be implemented in the form of hardware, software, or a combination of hardware and software and that the examples herein are merely illustrative. DBMS instructions 118 may configure processor 110 to generate database query responses, to update the database, to provide database usage statistics, or to serve any other database related function.

DBMS instructions 118 may configure processor 110 to implement the query optimization techniques disclosed herein. Such instructions may be encoded in nested query optimizer 114. DBMS instructions 118 may be realized in any non-transitory computer-readable media for use by or in connection with an instruction execution system such as a computer 102, an ASIC or other system that can fetch or obtain the logic from non-transitory computer-readable media and execute the instructions contained therein. “Non-transitory computer-readable media” can be any media that can contain, store, or maintain programs and data for use by or in connection with the instruction execution system. Non-transitory computer readable media may comprise any one of many physical media such as, for example, electronic, magnetic, optical, electromagnetic, or semiconductor media. More specific examples of suitable non-transitory computer-readable media include, but are not limited to, a portable magnetic computer diskette such as floppy diskettes or hard drives, a read-only memory (“ROM”), an erasable programmable read-only memory, or a portable compact disc.

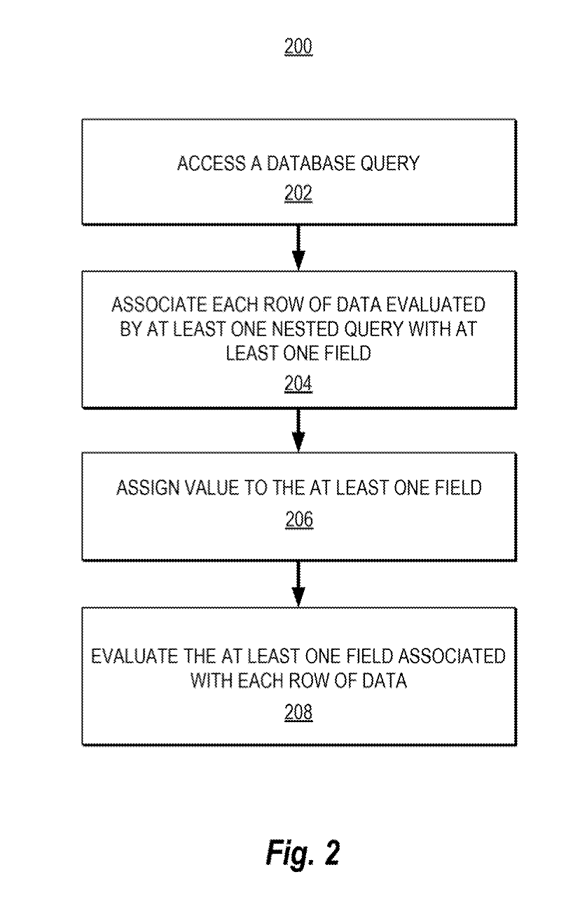

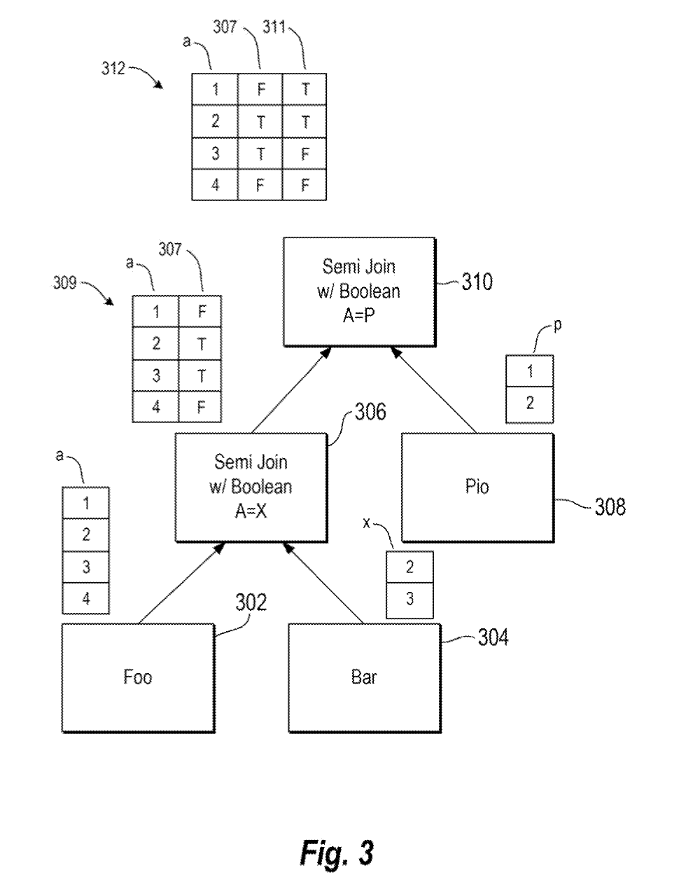

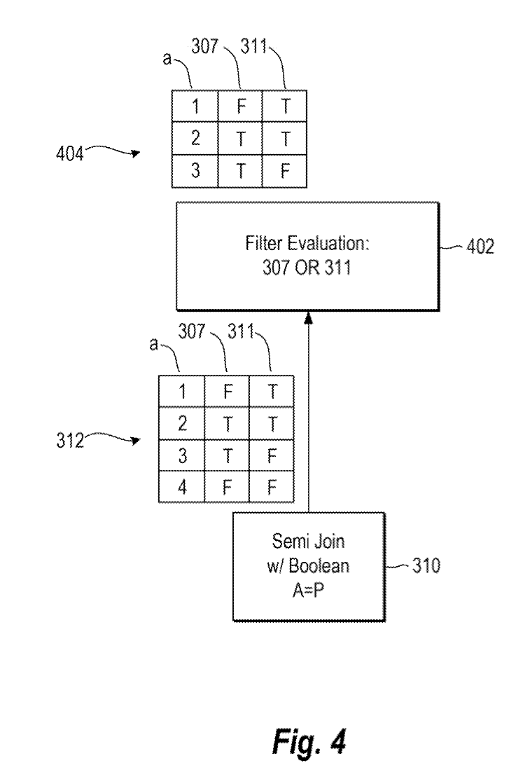

One working example of a system and method to optimize nested queries is shown in FIGS. 2-4. In particular, FIG. 2 shows a flow diagram of an illustrative process . for optimizing nested queries in accordance with aspects of the present disclosure. FIGS. 3-4 show various aspects of optimizing nested queries in accordance with the techniques disclosed herein. The actions shown in FIGS. 3-4 will be discussed below with regard to the flow diagram of FIG. 2.

As shown in block 202 of FIG. 2, a database query having at least one nested may be accessed. By way of example, the following query may be received by DBMS instructions 118:
select a from foo where a IN (select x from bar) OR a IN (select p from pio)

The query above requests rows in table foo that satisfy a first nested query “a IN (select x from bar)” and a second nested query “a IN (select p from pio).” Referring now to FIG. 3, one possible optimized execution plan of the above query is disclosed. Table 302 of FIG. 3 represents table foo. Table 302 is shown having four rows with a value of 1,2,3,4 in column a respectively. Table 304 represents the table bar and is shown having two rows with a value of 2 and 3 in column x respectively. Finally, table 308 represents the table pio and is shown having two rows with a value 1 and 2 in column p respectively. The rows of table 302 may be joined with the rows of table 304 using a “semi-join” module 306 in order to carry out the query “a IN (select x from bar).” A “semi-join” with join predicate a=x may be used to return rows from table 302 that match those found in table 304. Unlike a conventional join, a “semi-join” may return no more than one row from table 302 for each matching row in table 304, even if duplicate matches are found in table 304. Thus, a “semi-join” eliminates duplicate rows and is consistent with the “IN” operator in SQL.

Referring back to FIG. 2, each row of data evaluated by the at least one nested query may be associated with at least one field, as shown in block 204. In FIG. 3, field 307 may be associated with each row in table 302 evaluated by the first nested query, “a IN (select x from bar),” to generate intermediate output 309, which may be cached in memory 112. Referring back to FIG. 2, in block 206, a value may be assigned to the at least one field so as to indicate whether each row of data satisfies the at least one nested query. As shown in the example of FIG. 3, field 307 is assigned a value so as to indicate whether each associated row in table 302 satisfies the first nested query. In the example of FIG. 3, field 307 is a Boolean field that may have a value of “F” for false or “T” for true. In SQL, a Boolean field may also have a value of “unknown” or “null.” While the example of FIG. 3 uses Boolean fields, it is understood that any type of field and any type of value may be used to indicate whether a row of data satisfies a query. In the example of FIG. 3, a value of “T” may indicate that a particular row of table 302 satisfied the “where” clause of the nested query. The opposite may be true when the value is “F.” Thus, field 307 may be set to “T” when a row of table 302 satisfies “a IN (select x from bar).” As shown in FIG. 3, the only values of table 302 that satisfy this nested query are the rows with a value of 2 and 3 in column a, since table 304 contains two rows with the same values in column x.

In “semi join” module 310 of FIG. 3, the rows of table 302 may be evaluated against the rows of table 308 to determine whether any rows of table 302 satisfy the second nested query “a IN (select p from pio).” This may generate intermediate output 312, which may also be cached in memory 112. The rows of table 302 are associated with a second field 311 to indicate whether each row thereof satisfies the second nested query. As with field 307, field 311 is also shown as a Boolean field in the example of FIG. 3, but it is also understood that field 311 may be any type of field. As the rows of table 302 are evaluated against the rows of table 308, a value of “T” may be assigned to field 311 for each row of table 302 that satisfies the second nested query. A value of “F” may be assigned to field 311 for each row of table 302 that does not satisfy the second nested query. The only rows in table 302 satisfying the second nested query are the rows whose column a equals 1 and 2, since the rows in table 308 have the same values in column p.

Referring back to FIG. 2, the at least one field associated with each row of data may be evaluated, as shown in block 208. FIG. 4 shows intermediate output 312 being forwarded to filter and evaluation module 402. The filter and evaluation module 402 may disjunctively evaluate fields 307 and 311 of intermediate output 312 with an “OR” operator to reflect the disjunctive join of the original nested queries. The rows of intermediate output 312 that do not satisfy the operator may be filtered out, resulting in final output 404. The final results show that the rows in table 302 whose column a equal 1, 2, and 3 satisfy the disjunctively joined nested queries “a IN (select x from bar) OR a IN (select p from pio).”

In addition to nested queries that are disjunctively joined, other types of complex nested queries may be enhanced using indicator fields. A complex nested query may include conjunctively joined nested queries, such as (select max(x) from bar) +(select max(a) from foo). A complex nested query may also include a nested query whose output serves as input to another expression, such as (foo.a in (select x from bar) IS TRUE. The foregoing is a non-exhaustive list of complex query types that may be enhanced using the techniques described above.

Advantageously, the above-described system, method, and non-transitory computer readable medium enhance the performance of any nested query expression. Instead of filtering out data that fail a nested query, all data is preserved with an indication of whether each row thereof satisfied the nested query. In this regard, all the preserved data may be cached such that the database tables are accessed only once. Although the disclosure herein has been described with reference to particular examples, it is to be understood that these examples are merely illustrative of the principles of the disclosure. It is therefore to be understood that numerous modifications may be made to the examples and that other arrangements may be devised without departing from the spirit and scope of the disclosure as defined by the appended claims. Furthermore, while particular processes are shown in a specific order in the appended drawings, such processes are not limited to any particular order unless such order is expressly set forth herein. Rather, processes may be performed in a different order or concurrently, and steps may be added or omitted.

1. A system comprising:
a plurality of database tables, each database table having at least one row of data;
a processor to:
access a database query having at least one nested query;
associate at least one field with each row of data evaluated by the at least one nested query;
assign a value to the at least one field so as to indicate whether each row of data satisfies the at least one nested query; and
evaluate the at least one field associated with each row of data evaluated by the at least one nested query to determine satisfaction thereof.

2. The system of claim 1, wherein the field is a Boolean field.

3. The system of claim 2, wherein the value assigned to the field equals true when a row of data satisfies the at least one nested query.

4. The system of claim 1, wherein the at least one nested query comprises a plurality of nested queries that are disjunctively joined.

5. The system of claim 1, wherein the at least one nested query comprises a plurality of nested queries that are conjunctively joined.

6. The system of claim 1, wherein output of the at least one nested query serves as input for another expression in the database query.

7. The system of claim 1, wherein each row of data evaluated by the at least one nested query is cached in a memory.

8. A non-transitory computer readable medium having instructions stored therein, which if executed, cause a processor to:
access a database query having at least one nested query;
associate at least one Boolean field with each row of data evaluated by the at least one nested query;
assign a value to the Boolean field so as to indicate whether each row of data satisfies the at least one nested query; and
evaluate the at least one Boolean field associated with each row of data evaluated by the at least one nested query to determine satisfaction thereof.

9. The non-transitory computer readable medium of claim 8, wherein the value assigned to the Boolean field equals true when a row of data in a database table satisfies the at least one nested query.

10. The non-transitory computer readable medium of claim 8, wherein the at least one nested query comprises a plurality of nested queries that are disjunctively joined.

11. The non-transitory computer readable medium of claim 8, wherein the at least one nested query comprises a plurality of nested queries that are conjunctively joined.

12. The non-transitory computer readable medium of claim 8, wherein output of the at least one nested query serves as input for another expression in the database query.

13. The non-transitory computer readable medium of claim 8, wherein each row of data evaluated by the at least one nested query is cached in a memory.

14. A method comprising:
accessing, using a processor, a database query having at least one nested query;
associating, using the processor, at least one Boolean field with each row of data evaluated by the at least one nested query;
caching, using the processor, each row of data evaluated by the at least one nested query in a memory;
assigning, using the processor, a value to the Boolean field so as to indicate whether each row of data satisfies the at least one nested query; and
evaluating, using the processor, the at least one Boolean field associated with each row of data evaluated by the at least one nested query to determine satisfaction thereof.

15. The method of claim 14, wherein the value assigned to the Boolean field equals true when a row of data in a database table satisfies the at least one nested query.

16. The method of claim 14, wherein the at least one nested query comprises a plurality of nested queries that are disjunctively joined.

17. The method of claim 14, wherein the at least one nested query comprises a plurality of nested queries that are conjunctively joined.

18. The method of claim 14, wherein output of the at least one nested query serves as input for another expression in the database query.
